(19) United States
(12) Patent Application Publication
(10) Pub. No.: US 2023/0245008 A1
(43) Pub. Date: Aug. 3, 2023

(54) SYSTEM AND METHOD FOR USING ARTIFICIAL INTELLIGENCE AND MACHINE LEARNING TO STREAMLINE A FUNCTION

(71) Applicant: PICSELLO, INC., Larchmont, NY (US)

(72) Inventor: Jane GOODRICH, Larchmont, NY (US)

(21) Appl. No.: 17/927,553

(22) PCT Filed: May 25, 2021
(86) PCT No.: PCT/US2021/034044

§ 371 Date: Nov. 23, 2022

Related U.S. Application Data
(60) Provisional application No. 63/030,049, filed on May 26, 2020.

(51) Int. Cl. G06Q 10/0631; G06Q 10/1093

(52) U.S. Cl. CPC G06Q 10/0631; G06Q 10/1095

(57) ABSTRACT

The present disclosure provides systems and methods for streamlining a function of a business. The system may comprise a processing device, and a memory communicatively coupled to the processing device and including computer readable instructions, that when executed by the processing device, cause the processing device to execute the instructions. The instructions may cause the processors to: receive first data associated with a first function of the business; receive second data associated with the second function of the business; generate, by the artificial intelligence engine and by using the one or more machine learning models relying on the first data and the second data, recommendation data; output, to the business system, the recommendation data; receive response data associated with a selection of the recommendation data; and generate, based on the response data, a second function of the business.

### CROSS-REFERENCE TO RELATED APPLICATION

This application claims priority to and the benefit of U.S. Provisional Patent Application Ser. No. 63/030,049, filed on May 26, 2020, the entire disclosure of which is incorporated herein by reference.

### TECHNICAL FIELD

This disclosure relates generally to systems and methods for using artificial intelligence and machine learning to streamline a function of a business.

### BACKGROUND

Business owners, including entrepreneurs and professionals, often struggle to manage demands that are ubiquitous with operating a business. Demands include, but are not limited to, finances of the business, customer engagement, scheduling, pricing products or services, inventory/stocking, staffing, planning for time off, social medial outreach, and many others. Today's consumers demand optimal and on-demand operation of a business and its staff, including its owner. Many businesses, however, fail in one or more demands while exceeding in others. Ultimately, a lack of attention to one demand too often has a negative impact on a business' current income and growth. Often, start-up businesses fail to meet their full potential for the reasons and typically go out of business within the five (5) years.

### SUMMARY

The present disclosure provides systems and methods for streamlining a function of a business. In an aspect of the disclosure, a system for streamlining a function of a business is provided. The system may comprise a processing device, and a memory communicatively coupled to the processing device and including computer readable instructions, that when executed by the processing device, cause the processing device to execute the instructions. The instructions may cause the processors to: receive first data associated with a first function of the business; receive second data associated with the first function of the business; generate, by an artificial intelligence engine and by using one or more machine learning models relying on the first data and the second data, recommendation data; output, to the business system, the recommendation data; receive response data associated with a selection associated with the recommendation data; and generate, based on the response data, a second function of the business.

Another aspect of the disclosed embodiments includes a tangible, non-transitory computer-readable medium storing instructions that, when executed, cause a processing device to perform any of the methods, operations, or steps described herein.

Other technical features may be readily apparent to one skilled in the art from the following figures, descriptions, and claims.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a schematic of a system of the present disclosure.

FIG. 2 generally illustrates a flow diagram of a method of the present disclosure.

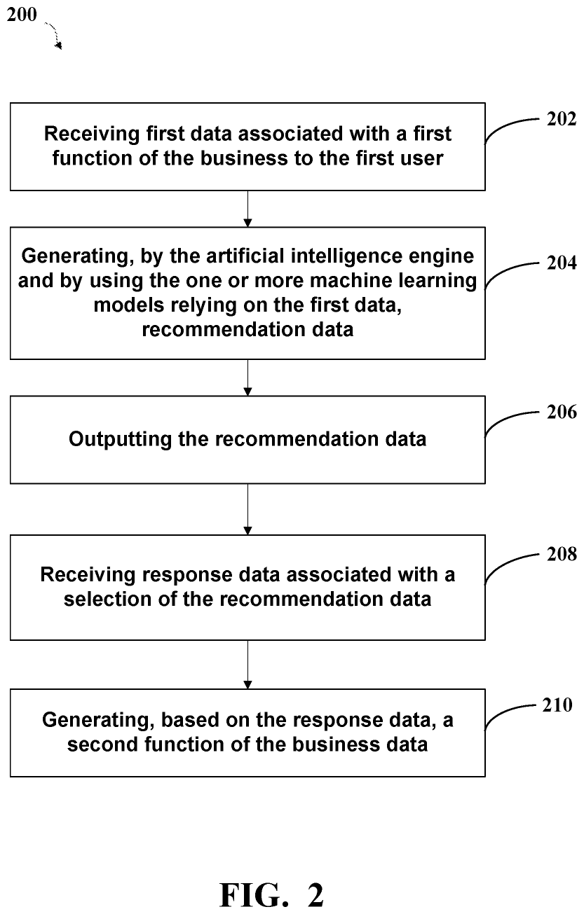

FIG. 3 generally illustrates a flow diagram of the systems and methods of the present disclosures, providing a hosted professional website and search/matching functionality.

FIG. 4 generally illustrates a flow diagram of the systems and methods of the present disclosures, providing a hosted professional website and search/matching functionality.

### NOTATION AND NOMENCLATURE

Before undertaking the DETAILED DESCRIPTION below, it may be advantageous to set forth definitions of certain words and phrases used throughout this patent document. The term “couple” and its derivatives refer to any direct or indirect communication between two or more elements, independent of whether those elements are in physical contact with one another. The terms “transmit,” “receive,” and “communicate,” as well as derivatives thereof, encompass both direct and indirect communication. The terms “transmit,” “receive,” and “communicate,” as well as derivatives thereof, encompass both communication with remote systems and communication within a system, including reading and writing to different portions of a memory device. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The terminology used herein is for the purpose of describing particular example embodiments only, and is not intended to be limiting. As used herein, the singular forms “a,” “an,” and “the” may be intended to include the plural forms as well, unless the context clearly indicates otherwise. The method steps, processes, and operations described herein are not to be construed as necessarily requiring their performance in the particular order discussed or illustrated, unless specifically identified as an order of performance. It is also to be understood that additional or alternative steps may be employed.

The terms first, second, third, etc. may be used herein to describe various elements, components, regions, layers and/or sections; however, these elements, components, regions, layers and/or sections should not be limited by these terms. These terms may be only used to distinguish one element, component, region, layer, or section from another region, layer, or section. Terms such as “first,” “second,” and other numerical terms, when used herein, do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” “top,” “bottom,” “right,” “left,” and the like, may be used herein. These spatially relative terms can be used for ease of description to describe one element's or feature's relationship to another element(s) or feature(s) as illustrated in the figures. The spatially relative terms may also be intended to encompass different orientations of the device in use, or operation, in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

Moreover, various functions described below can be implemented or supported by one or more computer programs, each of which is formed from computer readable program code and embodied in a computer readable storage medium. The terms “application” and “program” refer to one or more computer programs, software components, sets of instructions, procedures, functions, methods, objects, classes, instances, related data, or a portion thereof adapted for implementation in a suitable computer readable program code. The phrase “computer readable program code” includes any type of computer code, including source code, object code, and executable code. The phrase “computer readable storage medium” includes any type of medium capable of being accessed by a computer, such as read only memory (ROM), random access memory (RAM), a hard disk drive, a flash drive, a compact disc (CD), a digital video disc (DVD), solid state drive (SSD), or any other type of memory. A “non-transitory” computer readable storage medium excludes wired, wireless, optical, or other communication links that transport transitory electrical or other signals. A non-transitory computer-readable storage medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### DETAILED DESCRIPTION

The following discussion is directed to various embodiments of the present disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

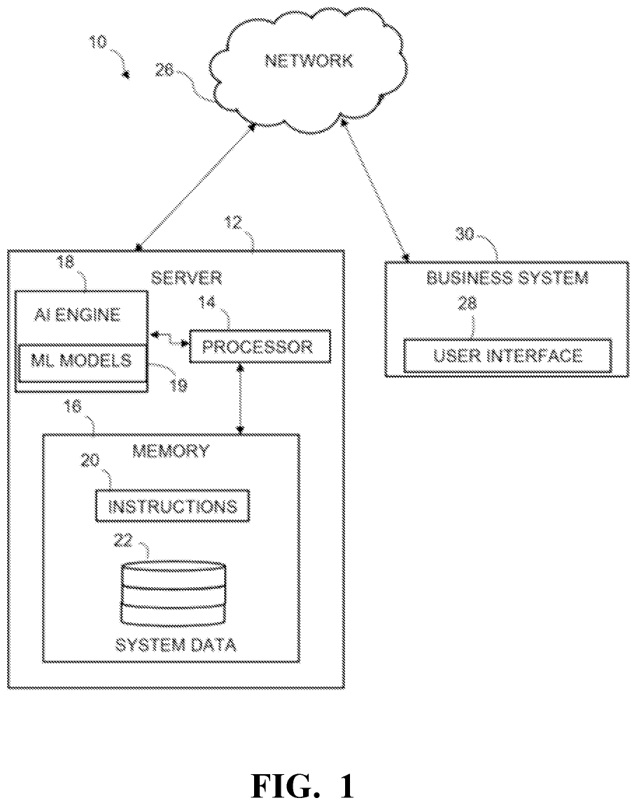

With reference now to the FIGS., a system and method is disclosed for streamlining a function of a business. FIG. 1 generally illustrates a block diagram of a computer-implemented system 10 and devices/hardware for streamlining a function of the business, hereinafter called “the system.” The system 10 may include a server 12 that may have one or more processing devices or processors 14, memory 16 having instructions 20 and system data 22, and an artificial intelligence engine (AI engine) 18 having machine learning models 19. The memory 16 may couple and communicate with the processors 14. The processor 14 may couple and communicate with the AI engine 18 and/or ML models 19. The server 10 may be configured to store (e.g., write to memory 16 and/or an associated memory) and to provide the system data 22 related to one or more functions of the business. More specifically, the memory 16 may provide machine-readable storage of computer readable instructions 20, and the system data 22 related to the function of the business.

The server 12 may include one or more computers and may take the form of a distributed and/or virtualized computer or computers. The server 12 may also configured to communicate with a first network 26. Although not included in the FIGS., the server 12 may include a first communication interface configured to communicate with the first network 26. The server 12 may also communicate with one or more networks of the system. In some embodiments, the first network 26, or any network of the system, may include wired and/or wireless network connections such as Wi-Fi, Bluetooth, ZigBee, Near-Field Communications (NFC), cellular data network, etc. that communicate with the server 12 and/or first communication interface.

The server 12 may execute the AI engine 18 to streamline a business function. In some embodiments, the AI engine 18 may reside on another component (e.g., the business system 30 or the user interface 28) depicted in FIG. 1 or be located remotely and configured to communicate with the network 26. The AI engine 18 may use one or more ML models 19 to perform any portion of the embodiments disclosed herein. The ML models 19 may be configured to identify and analyze data or otherwise be trained to cause the AI engine 19 to respond to data received by the processor 14.

In some embodiments, the server 12 may include a training engine (not shown in the FIGS.) capable of generating one or more ML models 19, and thereby, the AI engine 18. The ML models 19 may be generated by the training engine and may be implemented in computer instructions 20 executable by one or more processors of the training engine and/or the server 12. To generate the one or more ML models 19, the training engine may train the one or more ML models 19. The one or more ML models 19 may be used by the AI engine 18 and/or the server 12. The training engine may be a rackmount server, a router computer, a personal computer, a portable digital assistant, a smartphone, a laptop computer, a tablet computer, a netbook, a desktop computer, an Internet of Things (IoT) device, any other suitable computing device, or a combination thereof. The training engine may be cloud-based or a real-time software platform, and it may include privacy software or protocols, and/or security software or protocols.

In some embodiments, the AI engine 18 may comprise a single level of linear or non-linear operations (e.g., a support vector machine [SVM]) or a deep network, i.e., a machine learning model comprising multiple levels of non-linear operations. Examples of deep networks are neural networks including generative adversarial networks, convolutional neural networks, recurrent neural networks with one or more hidden layers, and fully connected neural networks (e.g., each neuron may transmit its output signal to the input of the remaining neurons, as well as to itself). For example, the machine learning model may include numerous layers and/or hidden layers that perform calculations (e.g., dot products) using various neurons.

The server 12 is configured to store data regarding one or more functions of a business, such as a scheduling task, financial task, stocking task, or ordering task. For example, the memory 16 includes a system data store 22 configured to hold first data, such as data pertaining to one or more functions of the business, among data associated with direct or indirect functions that support the productivity, service, or profits of a business. The server 12 is also configured to store data regarding performance (past, present, or future) of functions associated (directly or indirectly) with the business. For example, the memory 16 includes data associated with a preference of a tangible or intangible thing associated with the business, such as a preference of a customer, employee, owner of the business, or a preference for a procedure increasing productivity of the business (e.g., complete Task 1, Task 2 and Task 3 in sequential order, rather than completing the Task non-sequentially). The memory 16 further communicates with and cause the processor 14 to execute the instructions 20.

The instructions 20 may cause the processors 14 to receive first data associated with a function of the business. The business could be any kind of business, including a sole proprietor, limited liability company, independent contractor, individual, corporation, etc. The function of the business could comprise any act, service, product offering, or event of a business. In some embodiments, the function of the business could related to the performance of a function that provides a higher quality service or product, or performance of a task relating to a back-end business functions (e.g., review finances, pay bills, review inventory, review staffing, review/prepare supplies, learning a new skill, marketing, etc.). The function of the business may comprise an act that increases productivity of services, such as, but not limited to, photography or consulting services. For example, the function may comprise an act in preparation of a photoshoot, such as checking that a camera is in working condition prior to a photoshoot, checking for props, etc.

In some embodiments, the first function of the business may comprise a value of a product or service. In some embodiments, the first function may be the value a business charges for a service, alone or in combination with another service for product (e.g., a package service and product, a package of product, or a package of services (a collection of photos or series of phots), etc.). For example, the first function may be the average value charged by a photographer for an infant photoshoot. In another example, the first function may be the average value charged by a photographer for a physical printed copies and/or digital copies of photographs, one or more photoshoot sessions, photoshoot sessions with variables, such as the number of people being photographed, animals being photographed, changes of locations of the photoshoot, props used during the photoshoot, a particular occasion for the photoshoot such as engagement photos, or a new birth, and/or any other desired service.

In some embodiments, the average value may be the mean charge a cohort of businesses charge for a particular product and/or service. In some embodiments, the average value can associated with a cohort of business charge for a service or product, alone or in combination with another service for product (e.g., a package service and product, a package of services (e.g., a collection or series of photos), or a package of product, etc.). The cohort of businesses may comprises businesses within a geographical location, of a certain size, within an industry, within a subset of businesses in an industry, having a membership to an organization or group, or any other quantitative or qualitative relationship between businesses. In some embodiments, the average value may be the mean or median charge a cohort of photographers may charge for a wedding photoshoot and a series of photos (or phot package) associated with the shoot. In another embodiment, the average value may be the mean charge that photographers located within a particular geographical location and/or who subscribe to a network of photographers charge for a newborn photoshoot, and/or a photo package. In some embodiments, the average value may be the mean charge a cohort of attorneys or physicians charge for a particular service. In some embodiments, the average value may be the mean charge a cohort of accountants, financial planners, hair dressers, remodelers, landscapers, or other service providers charge for a particular service.

In some embodiments, the first function may comprise an event, such a as a photoshoot, meeting or any other business/professional event. An event could be a time a business is to provide a specific service. For example, the event could be a scheduled event to take photographs for a photoshoot, to meet with a client, or to complete a task/service for a client/customer, or any other desired task. In another example, the event could be to schedule a meeting, to attend a scheduled meeting, to complete a marketing task, to pay bills of the business, to hire an employee, to contact a customer/client, to create or review a business plan, to participate in an educational session (e.g., take a class, watch a video, etc.), or any other desired event.

In some embodiments, the first function may be a characteristic of one or more products or services. For example, a characteristic could be a high-level characteristic of a service, such as a style or category of a photoshoot (e.g., bridal, maternity, modeling, engagement, etc.). A characteristic could also be a low-level characteristic of a service, such as a specific detail of a photoshoot (e.g., color scheme, location, time of day, angle, lighting, etc.). Although the preceding examples are provided in the context of the photography industry, it should be appreciated that characteristics may be defined in any industry. For example, in the financial services industry, a high-level characteristic could be to review a client list, while a low-level characteristic could be review of the assets and investments of a specific client.

Additionally, or alternatively, the business' performance, function or any other characteristic, may be stored as a data in a memory 16 of the business system 30 and the server 12 (using the memory 16 and processor 14) may use one or more functions or characteristics to enable the server 12 to modify a function of the business and/or business system 30. For example, the server 12 may provide, to the user (e.g., customer, employee or business owner), one or more functions or characteristics of past business and/or customer performance, preference, like, and/or dislike.

The server 12 may also modify a first function of the business to a second function based on the business' or user's performance, preference, like, and/or dislike, in real-time or near real-time during the performance of a business function or based on a current, past or modified function, or any other measurement. For example, the server 12 may modify an appointment to reflect a preference of a customer, such as providing an indication that the customer likes photos taken at a certain time, angle, light, etc. The server 12, may also provide a prompt to the business system 30 and/or user interface 28 during a photoshoot by displaying an options or making a suggestions, such as changing the lighting, offering a future photoshoot, invoicing an up-charge, etc. There is no specific limit to the number of different type or kind of prompts that the business system 30 and/or user interface 28 may provide to streamline a business function. Additionally, real-time may refer to less than or equal to 2 seconds. Near real-time may refer to any interaction of a sufficiently short time, and will generally be less than 10 seconds but greater than 2 seconds. Near real-time, however, may be longer than 10 seconds, but will generally be less than a period of time wherein a communications results in the appearance to a user of a real-time function.

The instructions 20 may also cause the processor 14 to receive first data associated with the first function of the business. The processor 14 may receive the first data indirectly (e.g., through the network 26 as illustrated in FIG. 1) or directed from the business system 30. In some embodiments, the first data may be associated with a scheduled event of the business, such as a scheduled photoshoot. It should be appreciated that the first data may be associated with any one of the preceding functions discussed herein or any other function of a business.

In some embodiments, the business system 30 is integral with the server 12 or is a second server comprising common elements with the server 12, where such common elements may comprise, but are not be limited to, a business system processor, a memory, including business system instructions and business system data, a business system AI engine, and a business system M L model. The business system 30 may also comprise a user interface 28.

In some embodiments, the user interface 28 may be configured to provide voice-based functionalities, with hardware and/or software configured to interpret spoken instructions by a user. The system 10 may comprise one or more user interfaces 28. The user interface 28 may be associated with the business and/or one or more customers/clients of the business. The business system 30 and/or the user interface 28 may include one or more microphones facilitating voice-based functionalities. In some embodiment, the business system 30 and/or user interface 28 may include functionality provided by or similar to existing voice-based assistants such as Siri by Apple®, Alexa by Amazon®, Google® Assistant, Bixby® by Samsung, or any other desired assistance. The business system 30 and/or the user interface 28 may include other hardware and/or software components and may include one or more general purpose devices and/or special-purpose devices.

The user interface 28 may comprise a display taking one or more different forms including, for example, a computer monitor or display screen on a tablet, a smartphone, or a smart watch. The display may incorporate various visual, audio, or other presentation technologies. For example, the user interface 28 may include a non-visual display, such as an audio signal, which may include spoken language and/or other sounds such as tones, chimes, melodies, and/or compositions, which may signal different conditions and/or directions. The display may comprise one or more different display screens presenting various data and/or interfaces or controls for use by the user. The display may include graphics, which may present a message to the user (e.g., a notification to take an action to support a function of the business).

The instructions 20 may also cause the processor 14 to generate, by the AI engine 18 and by using the one or more ML models 19 relying on the first data, recommendation data. For example, the processor 14 may be configured to communicate the first data to the AI engine 18, and the AI engine 18 and/or the ML models 19 may be trained, in response to receiving the first data, to communicate to the processor recommendation data.

In some embodiments, the AI engine 18 and/or ML models 19 may be trained to identify any characteristic of the first data or data otherwise provided to the system 10. For example, the AI engine 18 and/or ML models 19 may be trained to identify first data associated with a first function, such as a scheduled photoshoot. For example, and in its most simplistic form, the AI engine 18 and/or ML models 19 may be trained to recognize the scheduled photoshoot and to generate a recommendation that includes providing recommendation data associated with a prompt to provide a remind the business and/or customer of the photoshoot. The AI engine 18 and/or ML models 19 may be trained to recognize a specific characteristic of the photoshoot, such as the time, location, anticipated weather at the location, the lighting at the location, and to respond by providing recommendation data associated with a prompt to suggest specific materials (e.g., camera, lenses, screens, makeup, and props) for the photoshoot. The AI engine 18 and/or ML models 19 may also be trained to identify weather conditions that would prevent the photo shoot from occurring and, in-real time or near-real time, provide recommendation data associated with a prompt to modify the time, date, locations, or any other aspect of the photoshoot and/or scheduled event. The AI engine 18 and/or ML models 19 may also be trained to provide recommendation data associated with an adjustment, in real time or near-real time, to the scheduled event. Recommendation data, such as suggested in the preceding example herein, optimizes a function of the business (e.g., rescheduling an event, checking the weather, confirming conditions of the photoshoot and comparing to materials for the photoshoot) by, in real-time or near real-time, providing recommendation data associated with an adjustment to the scheduled photoshoot. Thereby, the business may focus on other functions of the business.

The instructions 20 may also cause the processor 14 to output, to the business system 30, the recommendation data. In some embodiments, the business system 30 may receive the recommendation data and provide a prompt to the business and/or customer, where the prompt comprises a visual, an audible, or a tactile communication associated with the recommendation data. The prompt may be instructions displayed on the display of the user interface 28. The instructions may be communicated through the speakers or display of the business system 30 or user interface 28. The prompt may be a tactile communications, e.g., a vibration, sound, or other desired communication of the business system 30 or the user interface 28.

In some embodiments, the recommendation data may be associated with an option to make a selection. For example, if the recommendation data is associated with an indication to adjust a scheduled photoshoot due to weather, the recommendation data may comprise one or more optional dates, times or locations for the photoshoot. In such an example, the prompt or indication may communicate to the business and/or the customer the one or more options. In another example, the recommendation data may be associated with an indication for materials for a photo shoot or an educational suggestion (e.g., “Do not make a common mistake of many young photographers, remember to suggest a yearly photoshoot following each infant photoshoot.”).

The instructions 20 may also cause the processor 14 to receive response data associated with a selection of the recommendation data. In some embodiments, the response data may be associated with a selection of an alternative time, date, or location of a photoshoot. The response data may also be associated with a selection confirming a suggested change to a scheduled event or to scheduling an event. The response data may be associated with a selection made by the user, the business, or the system 10. In some embodiments, AI engine 18 may provide the response data to the processor 14 in real-time or near real-time. The response data may also be associated with no response. For example, the processor may receive response data associated with no selection of the recommendation data.

In some embodiments, the response data may be associated with a selection, by a user, with a touch screen display, or any other desired interface of the user interface 28. For example, the user or the business may select to reschedule a photoshoot at an alternative time. In some embodiments, the response data may be received, in real-time or near-real time, from the business system 30. In some embodiments, the business system 30 may comprise business system data associated with a preference for a function, or characteristic of a function, of the business and business instructions that cause the business processor to respond to recommendation data. For example, the business system 30 may comprise business system data associated with a pre-set of times and dates that a photoshoot may be rescheduled too. Therefore, if the business system 30 receive recommendation data to reschedule a photoshoot on a time and date that falls within the pre-set times and dates, the business instructions that cause the business processors to responds, in real-time or near real-time, the response data associated with an agreement with the rescheduled time. In some embodiments, the response data may be associated with a selection made by the AI engine 18 or the ML models 19. For example, the ML models 19 may learn a preferred characteristic of photo liked by the customer or the business and the response data may be associated with a selection of a preferred characteristic for that certain customer.

The instructions 20 may also cause the processor 14 to generate, based on the response data, a second function of the business. The second function of the business can differ from, or be the same as, the first function. The second function may also be similar to the first function, but comprise an addition, a deduction, or a modified, characteristic, relative to the one or more characteristics of the first function. For example, AI engine 18 or the ML models 19 may communicate response data, associated with inserting an indication of suggested material for a scheduled photoshoot, to the processor 14 and, in response, the processor 14 may insert the indication into the scheduled photoshoot (e.g., a note to a calendar meeting). As another example, AI engine 18 or the ML models 19 may communicate response data, associated with providing an educational communication, to the processor 14 and, in response, the processor 14 may communicate to the business system 30 to provide the education communication (e.g. “The average value charged by photographers in Detroit, Mich. for an engagement photoshoot is 55,000.”).

The following sets forth additional, non-limiting, examples of functions specific to a photography business. Based on the disclosure herein, one of skill in the art will readily appreciate that the following, non-limiting functions, may be incorporated into the system 10 and method 200 disclosed herein:

Hosted Professional Website & Search/Matching Functionality

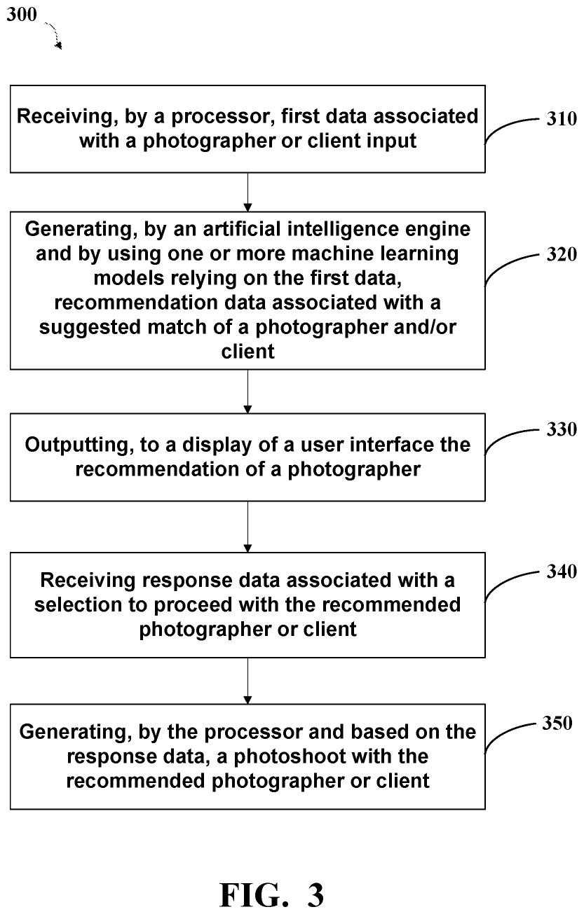

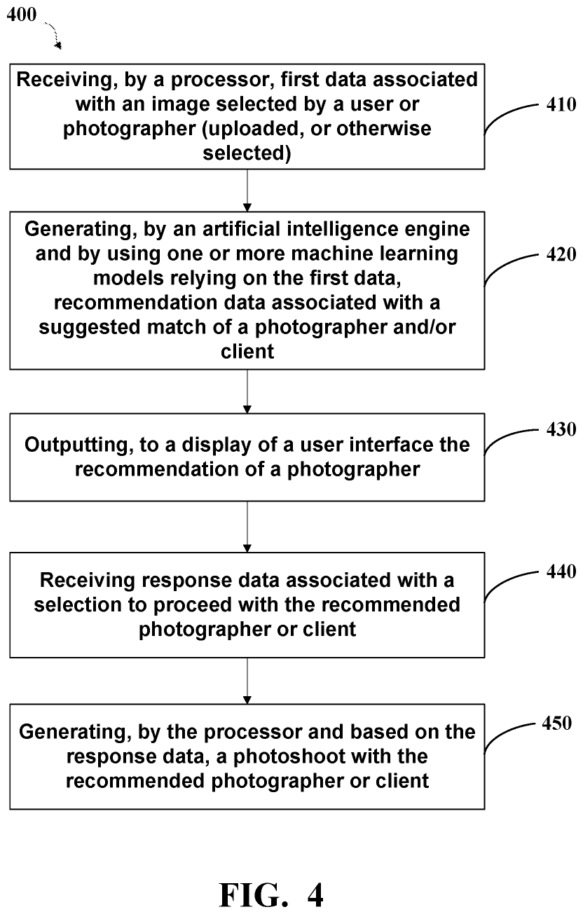

With reference to FIGS. 3 and 4, a flow diagram 300, 400 illustrates exemplary follow charts for providing a hosted professional website and search/matching functionality, such as providing:
The system 10 can facilitate client and photographer search and matching.
Photographer inputs relevant information: name, gallery, specializations, accreditations, awards, location, social/professional network links (e.g. Facebook, Instagram, and Linkedin), etc. With reference to the flow chart of FIG. 3, at step 310 the system 10 may receive, by the processor 14, first data that is associated with a photographer or a client input. As suggested at step 410 of FIG. 4, the first data may be associated with an image selected by a user or a photographer.
Client/photographer matching can also be facilitated by AI/ML. Clients can search for photographers based on schedule, availability, interests, current location, mutual connections on social/professional networks (e.g. “I need a photographer on 5/25/2023 at 10 am in the following zip code. 48220). Clients can upload images they like or select from an anonymous set of images from many photographers' galleries. Based on the results, photographers that match their style and aesthetic are presented. The AI engine 18 or the ML models 19 could be trained to identify characteristics of an image, such as tone, lighting, positioning, makeup, props, etc., and to identify like or similar characteristics between the client selected or uploaded image and images taken by a photographer. For example, and with reference to the flow chart of FIG. 3, at step 320 the AI engine 18 using the ML models 19 and the first data may generate recommendation data that is associated with a suggested match of a photographer and or client. As suggested at step 420 of FIG. 4, the first data may be associated with an image selected by a user or a photographer and matched with a specific user or photographer.
Client/photographer may receive an indication/notification of the recommended photographer/client that matched. For example, and as suggested as steps 330 and 430, respectively, the system may output to the user interface 28, the recommendation to the client/photographer.
Client/photographer may also select (e.g., approve by selecting) an indication on the user interface 28 that a match was made. For example, and as suggested at step 340 and 440 of FIGS. 3 and 4, respectively, the system 10 may receive a selection, by the client and/or photographer, to proceed with the recommended photographer. The client or photographer may confirm the photographer by interacting (e.g., touching/selecting) with a touch screen display of the user interface 28. In response, the processor 14 may generate, based on the response data, a photoshoot with the recommended photographer or client. For example, the processors 14 or AI engine 18 may, in-real time or near real-time, generate a calendar invite for the photoshoot, including the photographer and the client.
Client inquiries are sent to photographers.

It should be appreciated that FIGS. 3 and 4, including the preceding and forgoing, descriptions are not intended to be limiting. The exemplary steps of the flow charts are intended to provide more context to the disclosed embodiments and application of the same. The steps may include additional or less steps, and be executed by the system 10 and/or the method 200 disclosed herein.

Studio Manager/Shoot Scheduler
The system 10 can provide full spectrum customer relationship management (CRM) functionality once client relationships are established.
The system 10 can manage professional inventory and tools (e.g. lenses, lights, flashes, etc.).
The system 10 can track photographer and studio availability.
The system 10 can generate contract and send to clients for e-signature once bookings are made. The system 10 can store the signed contractions in the CRM.

Flow for Shoot Scheduler
Inbound client inquiries are sent to photographers via the system 100.
Clients can book and pay directly (deposit and balance) on the platform of the system 100.
Clients receive AI-generated suggestions for best times for specific shoots (e.g. ‘golden hour’ for outdoor photography, early morning/late afternoon for newborn photography, etc.).
Clients receive confirmation of shoot, including information and tips personalized for the client and the shoot type (tips for clothing, makeup, etc., for newborn, child, family, engagement, maternity photography).
Shoot scheduler immediately analyzes weather forecast for the scheduled shoot, reserves appropriate equipment (lenses, cameras, flash, etc.) and sends a checklist to photographer.
A photographer can set an auto-rebook option if weather forecast has ‘x %’ or higher rain chance for time of outdoor shoot.

Gallery/Proof Hosting
The system 10 can share proofs with clients so they can select and purchase photos and merchandise.
Clients can ‘share’ proofs with friends and family via social media, SMS, email, URL, etc.
Gamification functionality: Clients can share their top photo choices with friends, family, and social networks and request a ‘vote’ for best photos. Polls feature a link to the photographer's website.
When clients select photos they would like to purchase, they are automatically taken to an e-commerce marketplace with various options: purchase high-resolution digital file, or purchase prints and merchandise.

Product Ordering
Photographers curate personalized own e-commerce marketplace from a variety of vendors (featuring prints and merchandise), and select pricing based on the agreements with those vendors plus their desired margin. As an example, margin can be determined by the photographer and/or suggested by the pricing-for-profit educational module.
Clients select products and check out through the payment manager.

Payment Manager
The system 10 can automate the acceptance and reconciliation of all payments inbound from clients and outbound to vendors (e.g. product ordering).
This could comprise an API to a third-party payment management platform.

Raw Camera/Proof Backup
Photographers can save large camera raw files and client proofs in a secondary backup location.
The system 10 can contract with a cloud provider or physical storage provider (e.g. Rackspace) to provide secure, off-device storage for photographers.

Educational Platform
The system 10 can provide educational content for professional and business development. For example, the system 10 can provide financial literacy, pricing sessions based on specific markets, the basics of planning and running profitable small business.
Integrated with photographer's schedule, third party tools like accounting and billing, pricing and contracts, to provide real-time feedback and adjustments on profitability.

Third-Party Business/Administrative Tools
Clients upload photos they like (their own or others). These images are analyzed, and a report is sent to the photographer indicating the client's preferred style, color, mood, and aesthetic. The results also auto-generate communication to clients with tips on how to prepare, dress, what to bring, etc.
The system 10 can analyze client social media (with permission) to understand the photos they like to share, and which are their most ‘liked’ photos to understand their favorite colors, styles, poses, aesthetics, most popular facial angle or a “good side” to be photographed from.
Based on previous analysis, AI/ML can also analyze the raw files from the photo shoot and suggests which photos to cull and which to present to the client in the proof gallery. Photographer can override the pre-selected/pre-suggested image set.
Pricing-For-Profit analysis: Photographers input a variety of metrics (cost of living, insurance, desired annual income, etc.) and the system 10 can automatically run a profitability analysis to indicate whether shoot and product pricing should be adjusted. This is a quick version of the full educational module and provides photographers with a real-time insight into their profit models. If photographers have integrations with third party tools like QuickBooks, the system 10 can integrate actual financial statement analysis for these suggestions.
Educational modules are also AI-driven: courses on technique can be automatically ‘graded’ (e.g. testing f-stop, aperture, etc.) when photographers upload photos which are instantly assessed, and feedback given.
These are just some examples of the analytics and AI/ML-driven insights.

The present disclosure further provides a method 200 for streamlining a business function. The business function may comprise any of the functions discussed herein. The method 200 comprises the step 202 of receiving first data associated with a first function of the business. For example, the method may comprise receiving, by a processor such as processor 14, first data associated with a function of the business, such as scheduling a photoshoot. The method comprises the step 204 of generating, by an AI engine (such as AI engine 18) and by using the one or more ML models (such as ML models 19) relying on the first data, recommendation data. For example, the step may comprise of generating, by an AI engine (such as AI engine 18) and by using one or more ML models (such as ML models 19) relying on the first data, a recommendation to schedule a photoshoot. The method may comprise the step 206 of outputting the recommendation data. For example, the recommendation data may be output, or communicated to, the processor, AI engine, business system, a business, and/or a user. The method may comprise the step 208 of receiving response data associated with a selection of the recommendation data. For example, the response data may be received by the processor, an AI engine, or business system. The method may comprise the step 210 of generating, based on the response data, a second function of the business. For example, the processor may generate and change a scheduled photoshoot due to one or more conditions (e.g., weather, time, date, etc.).

The method may comprise the second function and the first function differing, and the second function may provide a financial change, relative to the first function, to the business. A financial change my results in a financial profit or loss for the business and/or the customer. For example, the financial change may comprise an increase of a price of a products or service. The first function may comprise a first price of a product or service and the second function may comprise an increase or decrease in the price for the product or service. The method may comprise the first function comprising an average value, where the average value is a mean charge that a cohort of businesses charges for at least one of a product and a service. The method may comprise the cohort of businesses being businesses within one or more of a geographical location, a size, an industry, a subset of businesses within an industry, a membership to a service, and a membership to an organization.

The method may comprise the first function comprises an event, and the second function comprises adjusting the event. The method may comprise the event being one of a scheduled meeting and scheduling a meeting. The adjusting the event comprises adjusting at least one of a time, a date, a location, a duration, an indication, and a detail of the event. The method may comprise receiving, from the business system, second data associated with a preference and the generating of the recommendation data may be a step of using the first data and the second data to generate the recommendation data.

The method may comprise the first function comprises a characteristic of one or more products or services, and wherein the preference comprises a selected characteristic. The method may also comprise generating a second function of the business comprises in real time or near real time generating the second function.

Consistent with the above disclosure, the examples of systems and methods enumerated in the following clauses are specifically contemplated and are intended as a non-limiting set of examples.

Consistent with the above disclosure, the examples of systems and method enumerated in the following clauses are specifically contemplated and are intended as a non-limiting set of examples.

Clause 1. A method for streamlining a function of a business, the method comprising:
receiving first data associated with a first function of the business;
generating, by an artificial intelligence engine and by using one or more machine learning models relying on the first data, recommendation data;
outputting the recommendation data;
receiving response data associated with a selection of the recommendation data; and
generating, based on the response data, a second function of the business.

Clause 2. The method of any preceding clause, wherein the second function and the first function differ, and the second function provides a financial change, relative to the first function, to the business.

Clause 3. The method of any preceding clause, wherein the first function comprises a value, where the value is a mean charge that a cohort of businesses charges for at least one of a product and a service.

Clause 4. The method of any preceding clause, wherein the cohort of businesses comprises businesses within one or more of a geographical location, a size, an industry, a subset of businesses within an industry, a membership to a service, and a membership to an organization.

Clause 5. The method of any preceding clause, wherein the first function comprises an event, and the second function comprises adjusting the event.

Clause 6. The method of any preceding clause, wherein the event is one of a scheduled meeting and scheduling a meeting.

Clause 7. The method of any preceding clause, wherein adjusting the event comprises adjusting at least one of a time, a date, a location, a duration, an indication, and a detail of the event.

Clause 8. The method of any preceding clause, further comprising receiving, from the business system, second data associated with a preference, and wherein generating the recommendation data is further defined as generating, using the first data and the second data, the recommendation data.

Clause 9. The method of any preceding clause, wherein the first function comprises a characteristic of one or more products or services, and wherein the preference comprises a selected characteristic.

Clause 10. The method of any preceding clause, wherein generating a second function of the business comprises in real-time or near real-time generating the second function.

Clause 11. A system for streamlining a function of a business, comprising:
a processing device; and
a memory communicatively coupled to the processing device and including computer readable instructions, that when executed by the processing device, cause the processing device to:
   receive first data associated with a first function of the business;
   receive second data associated with the second function of the business;
   generate, by the artificial intelligence engine and by using the one or more machine learning models relying on the first data and the second data, recommendation data;
   output, to the business system, the recommendation data;
   receive response data associated with a selection of the recommendation data; and
   generate, based on the response data, a second function of the business.

Clause 12. The system of any preceding clause, wherein the second function and the first function differ, and the second function provides a financial change, relative to the first function, to the business.

Clause 13. The system of any preceding clause, wherein the first function comprises an average value, where the average value is a mean charge that a cohort of businesses charge for at least one of a product and a service.

Clause 14. The system of any preceding clause, wherein the cohort of businesses comprises businesses within one or more of a geographical location, a size, an industry, a subset of businesses within an industry, a membership to a service, and a membership to an organization.

Clause 15. The system of any preceding clause, wherein the first function comprises an event, and the second function comprises adjusting the event.

Clause 16. The system of any preceding clause, wherein the event is one of a scheduled meeting and scheduling a meeting.

Clause 17. The system of any preceding clause, wherein adjusting the event comprises adjusting at least one of a time, a date, a location, a duration, an indication, and a detail of the event.

Clause 18. The system of any preceding clause, wherein the processor is further configures to receive, from the business system, second data associated with a preference, and to generate the recommendation data based on the first data and the second data.

Clause 19. The system of any preceding clause, wherein the first function comprises a characteristic of one or more products or services, and wherein the preference comprises a selected characteristic.

Clause 20. The system of any preceding clause, wherein generating the function of the business comprises in real-time or near real-time generating the function.

No part of the description in this application should be read as implying that any particular element, step, or function is an essential element that must be included in the claim scope. The scope of patented subject matter is defined only by the claims. Moreover, none of the claims is intended to invoke 25 U.S.C. § 104(f) unless the exact words “means for” are followed by a participle.

The foregoing description, for purposes of explanation, use specific nomenclature to provide a thorough understanding of the described embodiments. However, it should be apparent to one skilled in the art that the specific details are not required to practice the described embodiments. Thus, the foregoing descriptions of specific embodiments are presented for purposes of illustration and description. They are not intended to be exhaustive or to limit the described embodiments to the precise forms disclosed. It should be apparent to one of ordinary skill in the art that many modifications and variations are possible in view of the above teachings.

The above discussion is meant to be illustrative of the principles and various embodiments of the present invention. Once the above disclosure is fully appreciated, numerous variations and modifications will become apparent to those skilled in the art. It is intended that the following claims be interpreted to embrace all such variations and modifications.

What is claimed is:

1. A method for streamlining a function of a business, the method comprising:
receiving first data associated with a first function of the business;
generating, by an artificial intelligence engine and by using one or more machine learning models relying on the first data, recommendation data;
outputting the recommendation data;
receiving response data associated with a selection of the recommendation data; and
generating, based on the response data, a second function of the business.

2. The method of claim 1, wherein the second function and the first function differ, and the second function provides a financial change, relative to the first function, to the business.

3. The method of claim 2, wherein the first function comprises a value, where the value is a mean charge that a cohort of businesses charges for at least one of a product and a service.

4. The method of claim 4, wherein the cohort of businesses comprises businesses within one or more of a geographical location, a size, an industry, a subset of businesses within an industry, a membership to a service, and a membership to an organization.

5. The method of claim 2, wherein the first function comprises an event, and the second function comprises adjusting the event.

6. The method of claim 5, wherein the event is one of a scheduled meeting and scheduling a meeting.

7. The method of claim 5, wherein adjusting the event comprises adjusting at least one of a time, a date, a location, a duration, an indication, and a detail of the event.

8. The method of claim 1, further comprising receiving, from the business system, second data associated with a preference, and wherein generating the recommendation data is further defined as generating, using the first data and the second data, the recommendation data.

9. The method of claim 8, wherein the first function comprises a characteristic of one or more products or services, and wherein the preference comprises a selected characteristic.

10. The method of claim 1, wherein generating a second function of the business comprises in real-time or near real-time generating the second function.

11. A system for streamlining a function of a business, comprising:
a processing device; and
a memory communicatively coupled to the processing device and including computer readable instructions, that when executed by the processing device, cause the processing device to:
receive first data associated with a first function of the business;
receive second data associated with the second function of the business;
generate, by the artificial intelligence engine and by using the one or more machine learning models relying on the first data and the second data, recommendation data;
output, to the business system, the recommendation data;
receive response data associated with a selection of the recommendation data; and
generate, based on the response data, a second function of the business.

12. The system of claim 11, wherein the second function and the first function differ, and the second function provides a financial change, relative to the first function, to the business.

13. The system of claim 12, wherein the first function comprises an average value, where the average value is a mean charge that a cohort of businesses charge for at least one of a product and a service.

14. The system of claim 14, wherein the cohort of businesses comprises businesses within one or more of a geographical location, a size, an industry, a subset of businesses within an industry, a membership to a service, and a membership to an organization.

15. The system of claim 12, wherein the first function comprises an event, and the second function comprises adjusting the event.

16. The system of claim 15, wherein the event is one of a scheduled meeting and scheduling a meeting.

17. The system of claim 16, wherein adjusting the event comprises adjusting at least one of a time, a date, a location, a duration, an indication, and a detail of the event.

18. The system of claim 11, wherein the processor is further configures to receive, from the business system, second data associated with a preference, and to generate the recommendation data based on the first data and the second data.

19. The system of claim 18, wherein the first function comprises a characteristic of one or more products or services, and wherein the preference comprises a selected characteristic.

20. The system of claim 11, wherein generating the function of the business comprises in real-time or near real-time generating the function.
